(19) United States
(12) Patent Application Publication
(10) Pub. No.: US 2008/0021819 A1
(43) Pub. Date: Jan. 24, 2008

(54) METHOD AND SYSTEM FOR AN ASSET-BACKED COMMERCIAL PAPER CONDUIT

(75) Inventor: Michael Whang, Brooklyn, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/781,780

(22) Filed: Jul. 23, 2007

Related U.S. Application Data
(60) Provisional application No. 60/832,718, filed on Jul. 21, 2006.

(51) Int. Cl. G06Q 40/00

(52) U.S. Cl. 705/39

(57) ABSTRACT

An asset-backed commercial paper conduit issues commercial paper backed by a receipt which corresponds to a partnership share in a trust that holds a municipal bond. A market value of the commercial paper corresponds to a market value of the receipt, and a control right of the commercial paper substantially corresponds to a control right of the receipt. The control rights of the receipt include a right to veto or direct sale or acquisition of the municipal bond. Holders of the commercial paper and receipt are entitled to distributions of tax exempt income or a second commercial paper or receipt.

### PRIORITY APPLICATION

This application claims the benefit of U.S. Provisional Patent Application No. 60/832,718, filed Jul. 21, 2006. The entire contents of that application are incorporated herein by reference.

### INTRODUCTION

In one aspect, the present invention comprises a method and system for providing a conduit for issuing commercial paper backed by certain assets, for example, municipal bonds. Commercial paper is an instrument that provides, typically, a short term promissory note that can be backed by assets or unsecured. Inventions described herein relating to a commercial paper conduit for tax-exempt asset backed commercial paper may also be applied, as appropriate, to conduits for unsecured commercial paper and commercial paper secured by taxable assets.

Existing asset backed commercial paper (“ABCP”) programs may be used to finance a variety of assets. Interest paid in ABCP programs is typically subject to U.S. Federal income tax and state income taxes. Due to the tax treatment of interest arising in ABCP programs, tax-exempt assets, such as municipal bonds, have generally not been used as assets in ABCP conduits. However, certain aspects of the present invention overcome the limitations and disadvantages of the prior art and enable certain benefits of municipal bonds to be enjoyed by purchasers of commercial paper.

One embodiment of the invention is directed to a method comprising: issuing commercial paper backed by a receipt corresponding to a partnership share in a trust holding one or more municipal bonds; wherein a market value of the commercial paper corresponds to a market value of the receipt, and wherein a control right of the commercial paper substantially corresponds to a control right of the receipt; receiving payment for the commercial paper; and purchasing the receipt. In some embodiments of the invention the control right comprises a right to veto or direct an acquisition or sale of the one or more municipal bonds. In other embodiments, the commercial paper may have a maturity term or a rate in common with or substantially the same as the receipt. In other embodiments of the invention, at the end of the maturity term of the receipt, a receipt distribution for the receipt is received which can comprise one of tax-exempt income or a second receipt. In yet other embodiments of the invention, at the end of the maturity term of the commercial paper, a commercial paper distribution to a holder of the commercial paper is paid, which can comprise one of: tax-exempt income or a second commercial paper.

Another embodiment of the invention is directed to a method comprising: issuing a receipt comprising a partnership share of a trust holding one or more municipal bonds, wherein a market value of the receipt corresponds to a market value of the one or more municipal bonds, and wherein a provision of the receipt comprises a control right; receiving payment for the receipt; and purchasing the one or more municipal bonds. In some embodiments of the invention the control right comprises a right to veto or direct an acquisition or sale of the one or more municipal bonds. In some embodiments, the receipt provides collateral for backing commercial paper. In some embodiments, a distribution for a matured receipt may be paid, the distribution comprising tax-exempt income or a second receipt. In other embodiments, a distribution is via a liquidity facility when proceeds of the one or more municipal bonds are insufficient.

Another embodiment of the invention is directed to a receipt comprising: a maturity term; a specified rate; a control right; a purchase price of the receipt; wherein proceeds from a sale of the receipt are provided to a trust for purchasing one or more municipal bonds; and a partnership interest in the trust; wherein at the maturity term, a distribution according to the specified rate is paid to an owner of the receipt. In some embodiments of the invention the control right comprises a right to veto or direct an acquisition or sale of the one or more municipal bonds. In some embodiments, the distribution comprises tax-exempt income or a second receipt.

Another embodiment of the invention is directed to an asset backed commercial paper, the provisions of the commercial paper comprising: a maturity term; a control right, the control right substantially corresponding to a control right of a receipt issued by a trust holding one or more municipal bonds, the receipt providing collateral for backing the commercial paper; a purchase price of the commercial paper, the purchase price of the commercial paper corresponding to a market value of the receipt; wherein proceeds of a sale of the commercial paper are used to purchase the receipt issued by the trust; and wherein at the maturity term, a distribution based on the one or more municipal bonds is paid to an owner of the commercial paper. In some embodiments of the invention the control right comprises a right to veto or direct an acquisition or sale of the one or more municipal bonds. In some embodiments, the distribution comprises tax-exempt income or a second commercial paper. In other embodiments, the commercial paper has at least one provision in common with the receipt.

More details of various aspects of the invention will be apparent as further described herein.

### BRIEF DESCRIPTION OF THE DRAWINGS

FIG. 1 depicts a block diagram of a bond trust, assets and classes of interests according to an embodiment of the invention;

FIG. 2A depicts a flow diagram of initial issuance of asset backed commercial paper according to an embodiment of the invention;

FIG. 2B depicts a flow diagram at maturity of the asset backed commercial paper according to an embodiment of the invention; FIG. 3A depicts an example of initial issuance of classes of interest according to an embodiment of the invention;

FIG. 3B depicts an example of an initial issue of commercial paper according to an embodiment of the invention;

FIG. 4A depicts an example of payment of commercial paper according to an embodiment of the invention;

FIG. 4B depicts an example of rolling over new commercial paper according to an embodiment of the invention;

FIG. 5A depicts an example of cash flows at maturity of an asset according to an embodiment of the invention; and

FIG. 5B depicts an example of payment of commercial paper at maturity of an asset according to an embodiment of the invention.

### DETAILED DESCRIPTION

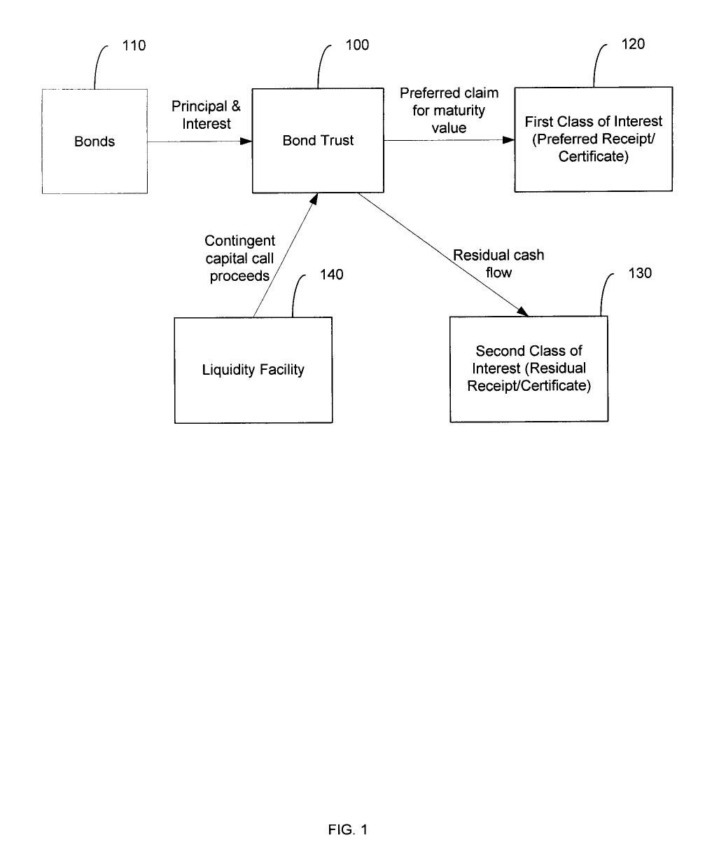

FIGS. 1-5 present various embodiments of systems and methods that enable a conduit for issuing asset backed commercial paper. Referring to FIG. 1, a bond trust 100 is provided to acquire, manage or otherwise hold one or more bonds 110, and issue classes of interests, such as a first class of interest 120, (also referred to as a preferred receipt, share or certificate (“Preferred”)), and a second class of interest 130, (also referred to as a residual, mezzanine or common interest or certificate (“Residual”)). The bonds 110 deposited in the bond trust 100 are generally municipal bonds, which are tax-exempt, but the inventions described herein may also be applied to other assets, tax-exempt or otherwise. The bond trust 100 may be established as a partnership or other entity that has advantageous federal income tax treatment, and may have prescribed rules or guidelines for providing, among other things, advantageous tax treatment, varying classes of interest, and other features. In some embodiments, the structure of the bond trust 100, classes of interest 120, 130, respective features of each, and relationships of the various parties/entities described herein may be as set forth in the exemplary summary of terms and conditions attached hereto as Appendix A.

In some embodiments, the bond trust 100 may be established to acquire and manage a portfolio of assets, such as a diversified portfolio of highly rated municipal bonds that satisfy certain specified criteria, e.g., as set forth in a bond trust agreement, or other investment guidelines. The activities of the bond trust 100 will typically be issuing certificates for one or more classes of interest (120, 130) in accordance with criteria for the certificates, acquiring and disposing of bonds 110, investing certain investments of the trust and other activities.

The one or more classes of interest (Preferred 120 and Residual 130), or other interests may have different terms, values, and other features, as described herein. In general, the market value of the Preferred 120 and the Residual 130 may be substantially equal to the market value of the Bonds 110. The Preferred receipt 120, in some embodiments, may have a stated maturity value, e.g., up to 270 days (or even to 397 days pursuant to 17 C.F.R. § 270.2a-7) and a stated interest rate. The Residual receipt 130 typically does not have a specified maturity term and interest rate. Other variations of the features (maturity term, interest rate, or other detail) of one or more classes of interest may be specified or unspecified within the purview of the invention. The Preferred 120 and Residual receipt 130 typically have specified entitlements, such as rights for repayment, control rights or other features.

The Preferred 120 may also have certain specified control rights over the assets or bonds 110 of the bond trust 100. Some examples of control rights include the right to veto an acquisition or sale of a bond 110 and the right to direct an acquisition or sale of a bond 110, or other rights. In some embodiments, a Residual 130 class may not have the same specified control rights as the Preferred 120, however, it is understood that control rights may be assigned to different classes of interest. Typically, a Residual receipt 130 may have a right to direct a sale of assets. The provision of control rights to the Preferred 120 or other class of interest may entitle the Preferred to be considered an equity share of the bond trust 100. By comparison, conventional classes of interest without certain control rights are typically considered to be debt.

In some embodiments, the bond trust 100 may be established as a partnership for federal income tax purposes. The Preferred 120 and Residual 130 may represent partnership or equity interests in the bond trust 100 and would not be considered debt of the bond trust. As such, the distribution of interest from the bonds 110, e.g., first to the Preferred 120 and then to the Residual 130, or as otherwise specified for the respective classes of interest, will be exempt from U.S. federal income tax.

As shown in FIG. 1, in some embodiments, money flows in the form of principal and interest on the one or more bonds 110 to the bond trust 100, which in turn pays a maturity value for the first class of interest (Preferred) 120 and any residual cash remaining after the first class of interest 120 has been paid, may be paid to the second class of interest (Residual) 130. Thus, Residual 130 are typically paid any principal, interest or other payments from the bonds 110 in excess of the amount needed to pay the Preferred 120. In some embodiments, holders of the Residual 130 may direct the bond trust 100 to sell bonds 110 and the proceeds of such sale may be allocated initially to the Preferred 120 until paid in full with the excess distributed to the Residual 130.

Such distributions or claims paid to a particular class of interest may be paid according to certain specified maturity terms, rates or other features of the respective class of interest, which may be set forth in one or more agreements. Some classes of interest may not have such specified items. In some instances, the bond trust 100 may have insufficient funds to pay the claims to the first class of interest (Preferred) 120. In such a situation, a holder of a second class of interest (Residual) 130 or other entity may be subject to a contingent capital call. In order to secure the contingent capital call, the holder of the Residual 130 will deliver a liquidity facility (the “Liquidity Facility”) 140 to the bond trust 100. The Liquidity Facility 140 may be provided by a financial institution, or other institution. The Liquidity Facility 140 may be used to pay the maturity value of Preferred 120 in the event that there are insufficient funds available to the bond trust 100 to pay the Preferred 120. In other embodiments, the Residual 130 may provide funds to pay the Preferred 120 using other facilities or in accordance with provisions of a contribution agreement or other agreement.

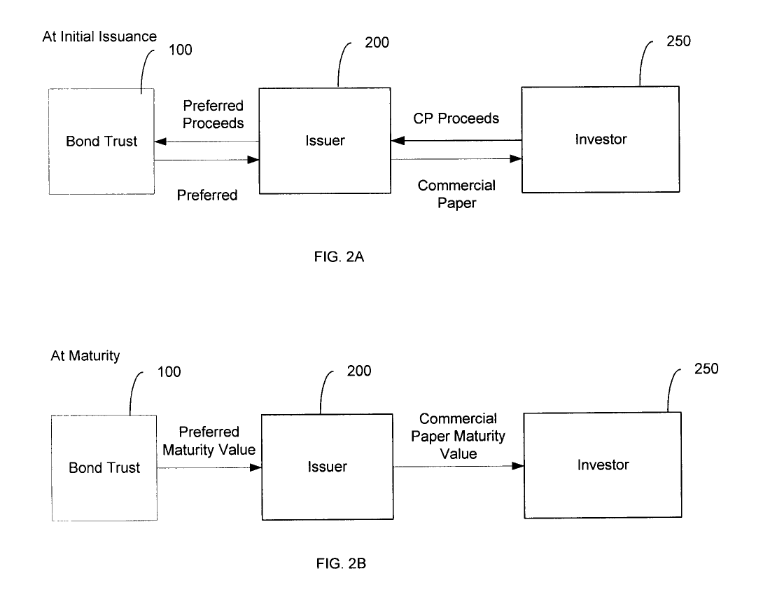

Turning to FIG. 2A, at issuance, the Preferred receipts may be issued by the bond trust 100 and deposited into a commercial paper conduit issuer (the “Issuer”) 200. The Issuer 200 may be a trust, such as a grantor trust, or other trust having advantageous tax treatment or that is otherwise suitable. The Issuer 200 will then issue commercial paper which may be sold to third parties, such as investors 250. In some embodiments, a second class of interest, e.g. a Residual receipt may be issued by the bond trust 100 concurrently or at a later stage. In some embodiments, a remarketing agent is used to sell the commercial paper to third parties. The Remarketing Agent (or other party) may set the term, price, rate or other feature of each tranche of commercial paper. Based on such term, price and rate, the Issuer 200 would purchase matching or appropriate Preferred 120.

In some embodiments, the commercial paper comprises a tax-exempt asset backed commercial paper (“TABCP”) which is designed to allow the tax-exempt character of underlying assets, e.g., municipal bonds, to flow through to the holders of the commercial paper. The commercial paper may also have substantially similar features and rights. Such TABCP can then be sold to investors who may be tax-exempt, such as tax-exempt money market funds, or other investors, such as one that may be seeking tax-exempt investments. In some aspects, a maturity value, rate, term of a tranche of commercial paper may match that of a series of Preferred 120, and/or other features of a class of interest (although this is not essential). The control rights of the Preferred 120 may also be included for the commercial paper. Thus, for tax purposes, a holder of commercial paper is deemed to have the same partnership or equity standing as the Preferred 120 and may take advantage of income tax exemption status of the underlying Preferred receipt and assets 110.

Referring now to FIG. 2B, at maturity of a series of Preferred 120, the bond trust 100 will redeem the Preferred 120. The Issuer 200 may use the redemption proceeds of the Preferred 120 to redeem a related tranche of commercial paper and pay the commercial paper maturity value to an investor 250. Those skilled in the art will recognize that the Preferred 120, other classes of interest, and the commercial paper may have a variety of different maturities and other features.

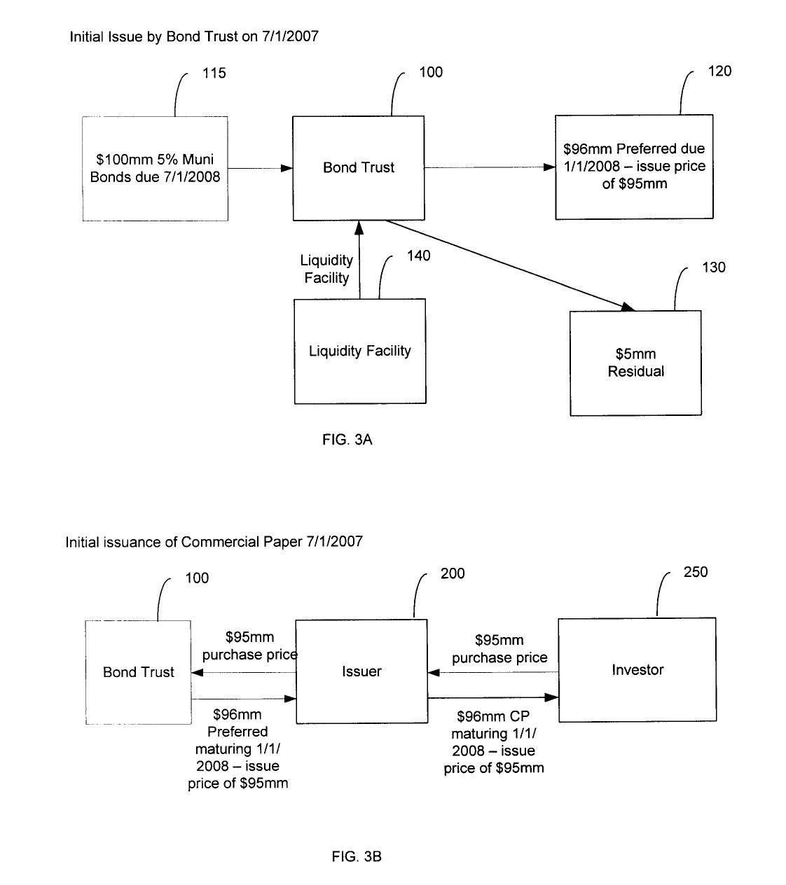

One exemplary embodiment is depicted in FIGS. 3A-5B. Referring to FIG. 3A, the bond trust 100 may issue, for example, on Jul. 1, 2007 $95 million in Preferred receipts which may have a maturity term to be due on Jan. 1, 2008 to pay a guaranteed $96 million at maturity. The assets or bonds 115 purchased by the bond trust 100 may be, for example, $100 million of 5% municipal bonds having a maturity date Jul. 1, 2008. Residual receipts 130 may be issued for the remaining $5 million concurrently or at a later date, e.g., if additional assets are purchased later, or to raise additional capital, or for other reasons. Thus, typically, the sum of the market values of the issued Preferred 120 and Residual 130 substantially equal the market value of the municipal bonds 115.

Commercial paper may be issued concurrently with the bond trust 100 issue on Jul. 1, 2007. The bond trust 100 issues to the Issuer 200 Preferred receipts having an issue price of $95 million, maturing Jan. 1, 2008 at $96 million. For such Preferred, the Issuer 200 issues commercial paper to investors 250 which has an issue price of $95 million, maturing Jan. 1, 2008 at $96 million. Although in this example, terms and rates for the Preferred and commercial paper match, other maturity terms and rates for the commercial paper may be used that do not exactly match that of a class of interest. The investor 250 pays the issuer 200 $95 million as the purchase price for the commercial paper. The issuer 200 then provides the $95 million commercial paper purchase proceeds to the bond trust 100, which may be used to purchase assets, such as municipal bonds or other assets.

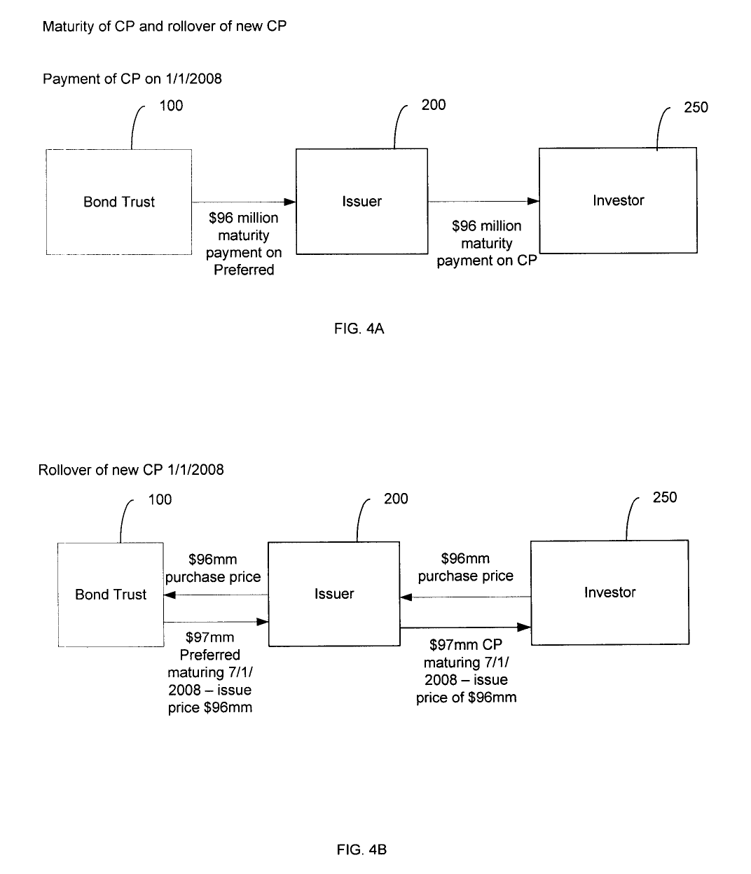

In the same example, at maturity of the commercial paper, proceeds flow according to the diagram depicted in FIG. 4A. On the maturity date, e.g., Jan. 1, 2008, the bond trust 100 pays the issuer 200 the $96 million maturity payment on the Preferred receipts. The issuer 200 then pays the investor 250 $96 million as the maturity payment on the commercial paper.

In other embodiments, new commercial paper may be issued to redeem matured commercial paper, as shown in FIG. 4B. At the time a series of Preferred matures, the bond trust 100 may issue a new series of Preferred. (Likewise, when another class of interest matures, a new series may issue.) For example, a new series of Preferred may have an issue price of $96 million (which matches the redemption price of the prior series of Preferred, but need not exactly match), and which matures Jul. 1, 2008 at $97 million. The issuer 200 may issue a new tranche of commercial paper at an issue price of $96 million and which matures on Jul. 1, 2008 at $97 million. The investors 250 payment of the $96 million issue price for the commercial paper to the issuer 200 may be used by the issuer 200 to purchase the Preferred or other class of interest from the bond trust 100.

The proceeds of the newly issued Preferred can be used to retire maturing Preferred to the extent that principal and interest payments from the Bonds are insufficient to pay the maturing Preferred. Preferred may also be paid from the sale proceeds of Bonds, or other asset that may be used to back the commercial paper, for example, if a sale has been requested by the holder of the Residual shares.

In some embodiments, if the Remarketing Agent is unable at any time to sell a new series or other additional Preferred, or other class of interest, the Issuer 200 may notify the Bond Trust 100 and the Bond Trust 100 may then redeem the Preferred by, for example, (i) payments made on the Bonds, (ii) proceeds from the sale of the Bonds, and/or (iii) a draw on the Liquidity Facility.

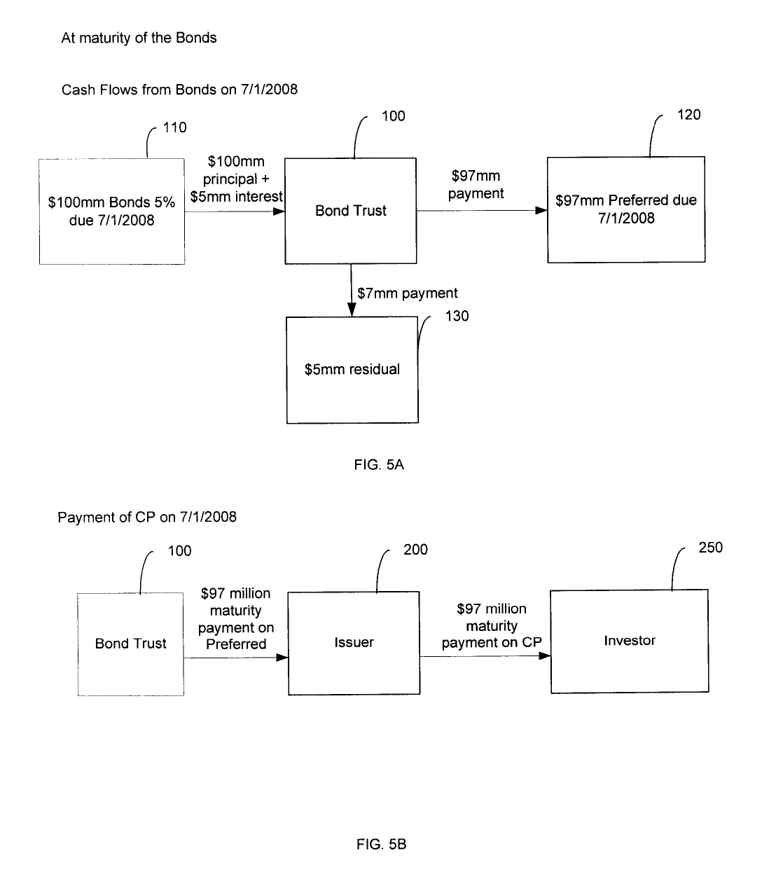

At maturity of the assets of the bond trust 100 cash flow from the assets (e.g., municipal bonds or other assets) may be as shown in FIG. 5A. At maturity on Jul. 1, 2008 of the $100 million of 5% municipal bonds 115 (FIG. 3A), $100 million of principal and $5 million of interest is paid to the bond trust 100. The Preferred certificates are redeemed by paying Preferred holders $97 million on Jul. 1, 2008 as set forth in the new Preferred issuance described with reference to FIG. 4B. The Residual are paid the remaining funds, $8 million, by the bond trust 100 for their $5 million issue price. At the same time, referring to FIG. 5B, the commercial paper matures and may be redeemed by the bond trust 100 paying the issuer 200 payment for the matured Preferred and the issuer 200 in turn pays the investor 250 the maturity payment $97 million on the commercial paper.

It will be appreciated that the present invention has been described by way of example only, and that improvements and modifications may be made to the invention without departing from the scope or spirit thereof.

### APPENDIX A

### Preliminary Summary of Terms and Conditions

### $[_{——————}] Municipal Bond Trust

### [_{——————}], 200[_{——————}]

The Municipal Bond Trust: . . . [_{——————}](the “Municipal Bond Trust”) is a newly-formed, special purpose, nominally capitalized, bankruptcy remote Delaware limited liability company established for the purpose of issuing Preferred Certificates and Common Certificates. The Municipal Bond Trust has no prior operating history. Pursuant to a trust agreement (the “Trust Agreement”), the Municipal Bond Trust has been established to acquire and manage a diversified portfolio of highly rated municipal bonds that satisfy specified criteria (each, an “Eligible Asset” and collectively, the “Eligible Assets”).

The activities of the Municipal Bond Trust will be limited to (i) issuing the Common Certificates, (ii) issuing the Preferred Certificates in accordance with the terms specified by the remarketing agent (the “Remarketing Agent”) pursuant to the Remarketing Agreement in effect on the Closing Date (the “Remarketing Agreement”), (iii) acquiring and disposing of Eligible Assets and investing and reinvesting in Eligible Investments as permitted by the Trust Agreement, (iv) entering into the Contribution Agreement, and (v) other activities incidental to the foregoing and permitted by the Trust Agreement.

Program Arranger: . . . Lehman Brothers, an investment bank.

Rating Agencies: . . . Neither the Common Certificates nor the Preferred Certificates will be rated by any rating agency.

Manager: . . . [_{——————}] (the “Manager”).

[Administrative Agent: . . . [_{——————}] (the “Administrative Agent”). Third parties may perform certain services for the Administrative Agent although the Administrative Agent will remain responsible for the performance of such services to the Municipal Bond Trust. Fees payable to the Administrative Agent will be a fixed negotiated amount and fees will be paid by (i) taxable income of the Municipal Bond Trust or (ii) an interested 3rd party. (To the extent required for US generally accepted accounting principles purposes, a majority of holders of Certificates may replace the Administrative Agent at any time subject to finding a suitable replacement administrative agent.)]

Depositary: . . . [_{——————}] (the “Depositary”). The Depositary will act as depositary for the safekeeping of, and issuing and paying agent for, the Certificates.

The Depositary shall pay each Certificate from funds available for such payment in the account established for such purpose.

Trustee: . . . [_{——————}] (the “Trustee”).

Structured Advisor: . . . Lehman Brothers, Inc.

Placement Agent: . . . Lehman Brothers, Inc.

Placement Agent Counsel: . . . TBD

Certificates: . . . The Municipal Bond Trust will issue Common Certificates and Preferred Certificates (collectively, the “Certificates”), in each case, with the principal terms set forth below.

The Certificates will be issued pursuant to the Trust Agreement. All amounts payable in respect of the Certificates will be paid solely from and to the extent of the available proceeds from the Trust Estate.

Use of Proceeds: . . . The proceeds of the offering of the Certificates will be applied by the Municipal Bond Trust (i) to purchase Eligible Assets, (ii) to make distributions to the holders of the Common Certificates, and (iii) to pay on the Closing Date organizational expenses and expenses relating to the issuance of the Certificates.

Preferred Certificates: . . . The Municipal Bond Trust expects to issue U.S.$[•] of Preferred Certificates to one or more Remarketing Trusts on the Closing Date and thereafter.

Common Certificates: . . . The Municipal Bond Trust expects to issue U.S.$[•] of Common Certificates to [•] investors on the Closing Date in exchange for contributions of Eligible Assets made by each investor to the Municipal Bond Trust (the “Common Contributions”). Each Common Certificate will be assigned a CUSIP number. The Common Certificateholders may include Lehman or another 3^{rd} party.

Contribution Agreement: . . . Under a contribution agreement (the “Contribution Agreement”) between the Municipal Bond Trust and the Common Certificateholders, each Common Certificateholder will be required to contribute additional capital (the “Additional Contributions”) if there is a failed remarketing; provided, however, that Common Certificateholders will not be obligated to provide Additional Contributions if (i) there is an Act of Bankruptcy with respect to the Municipal Bond Trust, (ii) if (A) there is no Principal Credit Source with respect to a particular Eligible Asset, a failure of payment of any installment of principal of or premium, if any, or interest on such Eligible Asset (whether by scheduled maturity, regular payment, acceleration, demand or otherwise), which failure shall continue unremedied for five days or (B) if there is a Principal Credit Source with respect to a particular Eligible Asset, a failure of such Principal Credit Source to make such payment of principal, premium or interest under the terms of its credit enhancement upon demand for such payment thereunder, which failure shall continue unremedied for five days, (iii) in respect of any Eligible Asset with long term ratings, the Rating Agencies downgrade such ratings below BBB—in the case of S&P and Baa3 in the case of Moody's or (iv) there is a determination with respect to any Eligible Asset that interest thereon is includable in the gross income of the owners thereof for U.S. federal income tax purposes (collectively, the “Impairment Events”). For purposes hereof, a “Principal Credit Source” means, in respect of any Eligible Asset, a AAA/Aaa rated counterparty thereof.

Liquidity Agreement: . . . Pursuant to the Trust Agreement, a capital account will be established for each Certificateholder. Each capital account will be (i) increased by an amount equal to capital contributions made by such holder and any income and gains provided to such holder in accordance with the Trust Agreement and (ii) reduced by an amount equal to any distributions received by such holder and any losses and expenses provided to such holder in accordance with the Trust Agreement. Distributions to Certificateholders will be limited to their Capital Accounts. Under liquidity agreements (each, a “Liquidity Agreement”) between [Lehman Brothers Inc.] (the “Liquidity Agent”) and each Common Certificateholder, the Liquidity Agent will (subject to the conditions referenced in such Liquidity Agreement) be required to loan each Common Certificateholder an amount equal to any Additional Contributions such Common Certificateholder is required to contribute under the Contribution Agreement. Each Common Certificateholder will be required to assign its rights (but not its obligations) under the Liquidity Agreement to the Municipal Bond Trust.

Remarketing Agreement: . . . The trustee of the Remarketing Trust (the “Remarketing Trustee”) will enter into a remarketing arrangement (the “Remarketing Agreement”) with Lehman Brothers. The Remarketing Agreement will contain the terms pursuant to which interests in the Preferred Certificates may be remarketed from time to time. If Lehman Brothers is unable to remarket 100% of the Preferred Certificates held by a Remarketing Trust on any day specified in the Remarketing Agreement, and such inability is not cured within [30] days, the Municipal Bond Trust will (i) make capital calls on the holders of the Common Certificates of the Municipal Bond Trust and, to the extent the proceeds of such capital calls are not sufficient to effect a remarketing of 100% of the Preferred Certificates, liquidate the assets of the Municipal Bond Trust. The proceeds of any such liquidation will be paid to the Remarketing Trust, as the holder of the Preferred Certificates, and will be used to redeem all of the Commercial Paper Notes unless the holders of the Commercial Paper Notes direct the Remarketing Trust to elect to continue the Municipal Bond Trust.

The Remarketing Trust: . . . The Remarketing Trust will be a newly-formed, special purpose, nominally capitalized, bankruptcy remote Delaware limited liability company established pursuant to the Master Trust Agreement for the purpose of acquiring the Preferred Certificates and remarketing interests therein from time to time. The assets of each Remarketing Trust will consist of the Preferred Certificates issued by the Municipal Bond Trust (the “Municipal Bond Trust”). On each day on which the Commercial Paper Notes are issued, the Trustee will segregate and identify the Preferred Certificates that collateralize the group of then-outstanding Commercial Paper Notes. Each such segregated, identified collateral pool will constitute a separate, distinct, grant or trust for U.S. tax purposes, each of which will exist for a period of time from and including the most recent date on which Commercial Paper Notes are issued until and excluding the next date on which Commercial Paper Notes are issued. The Remarketing Trust will enter into a Remarketing Agreement with Lehman Brothers.

The activities of each Remarketing Trust will be limited to (i) issuance of the Commercial Paper Notes, (ii) purchase of the Preferred Certificates, (iii) entering into the Remarketing Agreement, and (iv) other activities incidental to the foregoing and permitted by the Remarketing Agreement and the Master Trust Agreement. Cash flow derived from the Preferred Certificates, and upon the remarketing of the Preferred Certificates, will be the only source of funds available to make payments on the Commercial Paper Notes.

Accrual Period: . . . The period between remarketing dates, as specified in the Remarketing Agreement.

Distributions: . . . (A) On any payment date specified by the Remarketing Agent pursuant to the Remarketing Agreement, distributions shall be made. First, to each holder of the Preferred Certificates, proportionately based on the yield of the Preferred Certificates (i) the amount specified as due on that payment date by the Remarketing Agent pursuant to the Remarketing Agreement and (ii) 1% of any gain on the sale or other taxable disposition of the Eligible Assets, but only to the extent of allotment of net income and gain during the relevant Accrual Period. Each holder of the Common Certificates shall receive 99% of any gain on the sale or other taxable dispositions of the Eligible Assets.

(B) To the Preferred Certificates, principal collections on the Eligible Assets in the Municipal Bond Trust.

(C) To the Common Certificates, interest payments on the Eligible Assets that are not required to pay (i) the holders of the Preferred Certificates or (ii) related expenses of the Municipal Bond Trust.

(D) Liquidating distributions—On liquidation, the Preferred Certificates will receive the proceeds thereof to the extent required to pay the par amount thereof (plus any accrued interest thereon), and each Common Certificateholder shall receive an amount equal to the amount of the Certificateholder's capital account.

Eligible Assets: . . . The Municipal Bonds underlying each series of certificates will consist of general obligation bonds and revenue bonds rated “AAA” and “Aaa” by S&P and Moody's, respectively, (including, without limitation, any secured or unsecured note, asset-backed security or government security representing such bond), that satisfies the criteria (the “Eligibility Criteria”) specified below. General obligation bonds are bonds issued by states, municipalities and public authorities to finance their general operations. These bonds are repaid with general revenue and borrowings and may be backed by the full faith and credit, including the taxing and further borrowing power, of the state municipality or public authority issuing the bonds. Revenue bonds are bonds issued by states, municipalities and public authorities to finance the cost of buying, building, or improving various projects intended to generate revenue, such as airports, healthcare facilities, housing and municipal electric, water and sewer utilities. Generally, payments on revenue bonds depend solely on the revenues generated by the projects, excise taxes or state appropriations, and are not backed by the government's taxing power. In each case where an Eligible Asset carries more than one rating and where such ratings are not equivalent, the lowest of such ratings will be used in determining compliance with the Eligibility Criteria. Eligible Assets may be sold at the direction of the Administrative Agent to the extent that the proceeds of any sale are sufficient to pay any principal and interest payable on the related Certificates through maturity.

Eligibility Criteria

(a) The purchase price of an Eligible Asset should be at or below par.

(b) Each Eligible Asset shall be rated by S&P and Moody's. No Eligible Asset, rated independently or with additional monoline insurance, shall be purchased unless it is rated at least “AAA” by S&P and at least “Aaa” by Moody's. Interest payable on each Eligible Asset is not includable in the gross income of the holder of such Eligible Asset.

(c) No Eligible Asset held by the Municipal Bond Trust shall be subject to any withholding tax.

(d) Each Eligible Asset shall be freely transferable by the Municipal Bond Trust.

(e) Each Eligible Asset shall represent a senior interest, not a subordinated tranche.

(f) No variable funding certificates that require continued funding under the certificate interest shall be purchased. Only certificates that are close-ended and amortizing may be purchased.

(g) No Eligible Asset may be (i) an interest-only or principal-only security or (ii) a structured note where principal repayment is tied to a formula without a minimum floor of 100% (i.e., each Eligible Asset must provide for payment in full of its related principal balance).

(h) The Eligible Assets shall be denominated in U.S. Dollars.

(i) Eligible Assets shall not include any securities or other financial instruments which are “margin securities” for purposes of Regulation U of the Board of Governors of the Federal Reserve System.

Collection Account: . . . All Collections will be remitted to the Trustee and deposited into the Collection Account and will be available, to the extent described herein, for application in the manner and for the purposes described herein. Funds held in the Collection Account that are not used to purchase Substitute Eligible Assets will be invested as promptly as practicable in Eligible Investments¹ maturing prior to the next Payment Date.

Voting Rights: . . . The holders of the Preferred Certificates have the right to veto any acquisition or disposition of Eligible Assets by the Municipal Bond Trust after the Closing Date. If [Lehman Brothers] is unable to remarket 100% of the Preferred Certificates on any day, and such inability is not cured within [30] days, Municipal Bond Trust will liquidate unless a majority of the holders of the Preferred Certificates by face amount vote against such liquidation.

Fees: . . . [to be determined]

Settlement: . . . Unless otherwise agreed to, same day basis, in immediately available funds.

Minimum Denomination: . . . $500,000, with integral multiples of $1,000 in excess of $500,000.

Form of Certificates: . . . Book-entry through DTC, unless otherwise specified.

Define.

Closing Date: . . . [•], 200_{——————}

[Independent Accountants: . . . [•9], will periodically perform certain procedures relating to the Eligible Assets in the Municipal Bond Trust estate as required by the Trust Agreement.]

Certain Tax Considerations: . . . Each Certificateholder agrees by acquiring a Certificate to treat for U.S. federal income tax purposes (1) the Municipal Bond Trust as a partnership and (2) the Certificates as partnership interests in the Municipal Bond Trust, and to report income, gain, loss and deduction in accordance with the Schedules K-1 delivered by the Municipal Bond Trust.

Certain ERISA Considerations: . . . [to be determined]

[Legal Investment: . . . Institutions whose investment activities are subject to legal investment laws and regulations or to review by certain regulatory authorities may be subject to conditions on investment in the Certificates.]

[Rule 2a-7 Compliance: . . . For purposes of Rule 2a-7 of the Investment Issuer Act of 1940, as amended (“Rule 2a-7”), the Municipal Bond Trust will be considered to be the issuer of the Certificates. It is unlikely that any obligor of Eligible Assets owned by the Municipal Bond Trust will ever be a ten percent obligor.]

1933 Act Exemption: . . . Exempt from registration under Section 4(2) of the Securities Act of 1933, as amended.

Governing Law: . . . The laws of the State of New York.

### Preliminary Summary of Terms and Conditions

### $[_{——————}] Tax-Exempt CP Notes Conduit

### [_{——————}], 20[_{——————}]

Description of Transaction: . . . [_{——————}] may choose to establish a $[_{——————}] (initial program size) structured commercial paper conduit that will issue Commercial Paper Notes collateralized by Preferred Certificates issued by a Municipal Bond Trust, as described below. The Municipal Bond Trust will apply the proceeds received through the sale of such Preferred Certificates to purchase AAA/Aaa rated municipal bonds.

The Commercial Paper Notes will be issued by a remarketing trust (the “Remarketing Trust”) established under a master trust agreement (the “Master Trust Agreement”). The Trustee of the Remarketing Trust will (i) use the proceeds from the initial issuance of the Commercial Paper Notes to purchase Preferred Certificates issued pursuant to the terms of a municipal bond trust (the “Municipal Bond Trust”) and (ii) on each subsequent day on which Commercial Paper Notes are issued, apply the proceeds of such Commercial Paper Notes to (a) acquire additional Preferred Certificates, if any, that may be issued by the Municipal Bond Trust and (b) pay maturing Commercial Paper Notes, as described below.

The Preferred Certificates will be entitled to one percent (1%) of any net gains realized by the Municipal Bond Trust through sales of assets from time to time. These gains, if any, paid to the Preferred Certificates will be passed through to the holders of the Commercial Paper Notes then collateralized by such Preferred Certificates.

The trustee of the Remarketing Trust (the “Remarketing Trustee”) will enter into a remarketing arrangement (the “Remarketing Agreement”) with Lehman Brothers pursuant to which the segregated Preferred Certificates that collateralize Commercial Paper Notes may be remarketed from time to time. If Lehman Brothers is unable to remarket 100% of the segregated Preferred Certificates that collateralize Commercial Paper Notes on any day specified in the Remarketing Agreement, and such inability is not cured within [30] days, the Municipal Bond Trust will (i) make capital calls on the holders of the Common Certificates of the Municipal Bond Trust (to the extent provided under the terms of the Contribution Agreement) and (ii) if the proceeds of such capital calls are not sufficient to permit a remarketing of 100% of the segregated Preferred Certificates, liquidate the assets of the Municipal Bond Trust. The proceeds of any such liquidation will be paid to the Remarketing Trust, as the holder of the Preferred Certificates and will be used to redeem all of the Commercial Paper Notes unless the holders of the Commercial Paper Notes direct the Remarketing Trust to elect to continue the Municipal Bond Trust.

Conduit Type: . . . High-Grade Tax-Exempt Commercial Paper Note Conduit.

Program Arranger: . . . Lehman Brothers, an investment bank

Conduit Rating Agencies: . . . Standard & Poor's (“S&P”) and Moody's Investors Service (“Moody's” and together with S&P, the “Rating Agencies”).

The Remarketing Trust: . . . The Remarketing Trust will be a newly-formed, special purpose, nominally capitalized, bankruptcy remote Delaware limited liability company established pursuant to the Master Trust Agreement for the purpose of acquiring the Preferred Certificates and remarketing interests therein from time to time. The assets of the Remarketing Trust will consist of the Preferred Certificates issued by the Municipal Bond Trust. On each day on which the Commercial Paper Notes are issued, the Remarketing Trustee will segregate and identify specific Preferred Certificates that will collateralize those Commercial Paper Notes. The Commercial Paper Notes will have recourse only against the segregated Preferred Certificates collateralizing those Commercial Paper Notes. The Remarketing Trust will enter into a Remarketing Agreement with Lehman Brothers with respect to the Preferred Certificates.

The activities of the Remarketing Trust will be limited to (i) issuance of the Commercial Paper Notes, (ii) purchase and sale of the Preferred Certificates, (iii) entering into the Remarketing Agreement, and (iv) other activities incidental to the foregoing and permitted by the Remarketing Agreement and the Master Trust Agreement. Cash flow derived from the Preferred Certificates, and upon the remarketing of the Preferred Certificates, will be the only source of funds available to make payments on the Commercial Paper Notes.

Remarketing Trustee: . . . [ ]

Depositary: . . . [_{——————}] (the “Depositary”). The Depositary will act as depositary for the safekeeping of, and issuing and paying agent for, the Commercial Paper Notes. The Depositary shall pay each Commercial Paper Note from funds available for such payment in the account established for such purpose.

Trustee: . . . [_{——————}] (the “Trustee”).

Structured Advisor: . . . Lehman Brothers, Inc.

Placement Agent: . . . Lehman Brothers, Inc.

Placement Agent Counsel: . . . TBD

Notes: . . . Commercial paper notes (each, a “Commercial Paper Note” and, collectively, the “Commercial Paper Notes”) having maturities between 1 and 397 days, as determined by the Remarketing Agent and set forth in the Remarketing Agreement.

Use of Proceeds: . . . The proceeds of the Commercial Paper Notes will be used to acquire Preferred Certificates.

Preferred Certificates: . . . For a description of the terms of the Preferred Certificates, see the Municipal Bond Trust Summary attached hereto as Exhibit A (the “Municipal Bond Trust Summary”).

Program Size: . . . Initially US $[_{——————}], which amount may be increased from time to time subject to the limitation that the aggregate face amount (i.e., principal and interest at maturity) of the outstanding Commercial Paper Notes may not exceed the total U.S. Dollar commitment set forth in the Contribution Agreement less net contributions under the Contribution Agreement. For a description of the terms of the Contribution Agreement, see the Municipal Bond Trust Summary.

Program Ratings: . . . The Commercial Paper Notes will carry the following credit ratings:

S&P: “A-1”

Moody's: “P-1”

Remarketing Agent: . . . [Lehman Brothers, Inc.]

Remarketing Agreement: . . . [describe Remarketing Agreement between Remarketing Trust and Lehman Brothers.]

Limitations on Issuance: . . . Commercial Paper Notes may not be issued if the Commercial Paper Notes are not rated at least “A-1”/“P-1,”

Fees: . . . [to be determined]

Offering Price: . . . Par less a discount representing an interest factor or, in the case of interest bearing Commercial Paper Notes, par.

Voting Rights: . . . With the prior written consent of at least [66%]% of the holders of all outstanding Commercial Paper Notes issued by the Remarketing Trust, the Remarketing Trustee may amend the Master Trust Agreement or the Remarketing Agreement to add, change or eliminate any provision of the Master Trust Agreement or modify in any manner the rights of the holders of the Commercial Paper Notes. Such amendment will be conclusive and binding on all present and future holders of the Commercial Paper Notes.

Voting of the Preferred Certificates. The Remarketing Trust will have the right to exercise any vote granted to the holders of the Preferred Certificates. The Trustee will exercise any such vote as directed by the holders of the Commercial Paper Notes, voting on a pro rata basis.

Votes Affecting Grantor Trust Status. Notwithstanding the foregoing, the prior written consent of 100% of the holders of the Commercial Paper Notes will be required to direct the vote of the Trustee with respect to the Remarketing Trust, the Master Trust Agreement and/or the Commercial Paper Notes, or an amendment to the Master Trust Agreement, Remarketing Agreement, or the Commercial Paper Notes, if the adoption of such amendment or the results of such vote would cause the segregated, identified Preferred Certificates that collateralize Commercial Paper Notes to fail to be treated as a grantor trust, or the Commercial Paper Notes fail to be treated as equity in such grantor trust, for U.S. federal income tax purposes.

Redemption: . . . Commercial Paper Notes will not be subject to early redemption at the option of the Remarketing Trust or to prepayment at the option of the holder.

Settlement: . . . Unless otherwise agreed to, same day basis, in immediately available funds.

Minimum Denomination: . . . $500,000, with integral multiples of $1,000 in excess of $500,000.

Form of Certificates: . . . Book-entry through DTC, unless otherwise specified.

[Independent Accountants: . . . [•], will periodically perform certain procedures relating to the trust estate as required by the Master Trust Agreement.]

Tax Treatment: . . . Each Commercial Paper Noteholder agrees by acquiring a Commercial Paper Note to treat (i) the Commercial Paper Notes as equity in a grantor trust consisting of the segregated, identified Preferred Certificates that collateralize those Commercial Paper Notes, and (ii) the Preferred Certificates as partnership interests in the Municipal Bond Trust, for U.S. federal income tax purposes. See the Municipal Bond Trust Summary.

Certain ERISA Considerations: . . . [to be determined]

[Rule 2a-7 Compliance: . . . For purposes of Rule 2a-7 of the Investment Company Act of 1940, as amended (“Rule 2a-7”), the Remarketing Trust will be considered to be the issuer of the Commercial Paper Notes.]

1933 Act Exemption: . . . Exempt from registration under Section 4(2) of the Securities Act of 1933, as amended.

Governing Law: . . . The laws of the State of New York.

What is claimed is:

1. A method comprising:
issuing commercial paper backed by a receipt corresponding to a partnership share in a trust holding one or more municipal bonds; wherein a market value of the commercial paper corresponds to a market value of the receipt, and wherein a control right of the commercial paper substantially corresponds to a control right of the receipt;
receiving payment for the commercial paper; and
purchasing the receipt.

2. The method of claim 1 wherein the control right comprises a right to veto an acquisition of the one or more municipal bonds.

3. The method of claim 1 wherein the control right comprises a right to veto a sale of the one or more municipal bonds.

4. The method of claim 1 wherein the control right comprises a right to direct an acquisition of the one or more municipal bonds.

5. The method of claim 1 wherein the control right comprises a right to direct a sale of the one or more municipal bonds.

6. The method of claim 1 wherein the commercial paper has a maturity term in common with the receipt.

7. The method of claim 1 wherein the commercial paper has a rate substantially the same as a rate for the receipt.

8. The method of claim 7 further comprising, at the end of the maturity term of the receipt, receiving a receipt distribution for the receipt.

9. The method of claim 7 further comprising, at the end of the maturity term of the commercial paper, paying a commercial paper distribution to a holder of the commercial paper.

10. The method of claim 8 wherein the receipt distribution comprises one of: tax-exempt income or a second receipt.

11. The method of claim 9 wherein the commercial paper distribution comprises one of: tax-exempt income or a second commercial paper.

12. A method comprising:
issuing a receipt comprising a partnership share of a trust holding one or more municipal bonds, wherein a market value of the receipt corresponds to a market value of the one or more municipal bonds, and wherein a provision of the receipt comprises a control right;
receiving payment for the receipt; and
purchasing the one or more municipal bonds.

13. The method of claim 12 wherein the control right comprises a right to veto an acquisition of the one or more municipal bonds.

14. The method of claim 12 wherein the control right comprises a right to veto a sale of the one or more municipal bonds.

15. The method of claim 12 wherein the control right comprises a right to direct an acquisition of the one or more municipal bonds.

16. The method of claim 12 wherein the control right comprises a right to direct a sale of the one or more municipal bonds.

17. The method of claim 12 wherein the receipt provides collateral for backing commercial paper.

18. The method of claim 12 further comprising paying a distribution for a matured receipt.

19. The method of claim 18 wherein the distribution comprises tax-exempt income.

20. The method of claim 18 wherein said step of paying comprises issuing a second receipt.

21. The method of claim 18 wherein said step of paying a distribution is via a liquidity facility when proceeds of the one or more municipal bonds are insufficient.

22. A receipt, the provisions of the receipt comprising:
a maturity term;
a specified rate;
a control right;
a purchase price of the receipt; wherein proceeds from a sale of the receipt are provided to a trust for purchasing one or more municipal bonds; and
a partnership interest in the trust;
wherein at the maturity term, a distribution according to the specified rate is paid to an owner of the receipt.

23. The receipt of claim 22 wherein the control right comprises a right to veto an acquisition of the one or more municipal bonds.

24. The receipt of claim 22 wherein the control right comprises a right to veto a sale of the one or more municipal bonds.

25. The receipt of claim 22 wherein the control right comprises a right to direct an acquisition of the one or more municipal bonds.

26. The receipt of claim 22 wherein the control right comprises a right to direct a sale of the one or more municipal bonds.

27. The receipt of claim 22 wherein the distribution comprises tax-exempt income.

28. The receipt of claim 22 wherein the distribution comprises a second receipt.

29. An asset backed commercial paper, the provisions of the commercial paper comprising:
a maturity term;
a control right, the control right substantially corresponding to a control right of a receipt issued by a trust holding one or more municipal bonds, the receipt providing collateral for backing the commercial paper;
a purchase price of the commercial paper, the purchase price of the commercial paper corresponding to a market value of the receipt;
wherein proceeds of a sale of the commercial paper are used to purchase the receipt issued by the trust; and
wherein at the maturity term, a distribution based on the one or more municipal bonds is paid to an owner of the commercial paper.

30. The commercial paper of claim 29 wherein the control right comprises a right to veto an acquisition of the one or more municipal bonds.

31. The commercial paper of claim 29 wherein the control right comprises a right to veto a sale of the one or more municipal bonds.

32. The commercial paper of claim 29 wherein the control right comprises a right to direct an acquisition of the one or more municipal bonds.

33. The commercial paper of claim 29 wherein the control right comprises a right to direct a sale of the one or more municipal bonds.

34. The commercial paper of claim 29 wherein the distribution comprises tax-exempt income.

35. The commercial paper of claim 29 wherein the distribution comprises a second commercial paper.

36. The commercial paper of claim 29 wherein the commercial paper has at least one provision in common with the receipt.
